(19) United States
(12) Patent Application Publication
(10) Pub. No.: US 2009/0279311 A1
(43) Pub. Date: Nov. 12, 2009

(54) ILLUMINATION DEVICE

(75) Inventors: FANG-XIANG YU, Shenzhen City (CN); SHUN-YUAN JAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/195,432

(22) Filed: Aug. 21, 2008

(30) Foreign Application Priority Data
May 7, 2008 (CN) 200810066970.6

(51) Int. Cl. F21V 7/00; G02B 3/08

(52) U.S. Cl. 362/310; 359/742

(57) ABSTRACT

A lens (11) of an illumination device (10) includes a body (110), a light output surface (12) located on a top of the body and a plurality of recesses (120) defined in the light output surface. The recesses extend along a transverse direction of the light output surface and are distributed along a longitudinal direction thereof. Each of the recesses includes a concave, curved wall (122) and a vertical wall (123). The recesses are divided into two groups symmetrically located on the light output surface and arranged at two sides with respect to a middle recess (120a) defined in a middle portion of the light output surface. An LED (14) is received in a groove (126) defined in a bottom of the body of the lens. The lens and the LED are mounted on a reflective base (16).

### BACKGROUND

1. Field of the Invention

The present invention generally relates to an illumination device, and particularly to an illumination device incorporating an optical lens, which can obtain a broad illuminating range.

2. Description of Related Art

With the continuing development of scientific technology, light emitting diodes (LEDs) have been widely used in illumination devices to substitute for conventional cold cathode fluorescent lamps (CCFL) due to their high brightness and long life-span.

In a conventional street lamp using LEDs as light sources, the LEDs are often secured to a horizontal base which can provide heat dissipation for the LEDs. For obtaining a broad illumination range, the base is required to have a complicated shape, which includes a slanting surface or a vertical surface. The LEDs attached to the slanting or vertical surface of the base can provide a broader illumination range than the LEDs on the horizontal base. However, the complicated base has a high cost.

What is needed, therefore, is an illumination device using LEDs, which can provide a broad illumination range and has a simple structure and a low cost.

### SUMMARY

A lens of an illumination device includes a body, a light output surface and a plurality of recesses. The light output surface is located on a top of the body. The recesses are defined in the light output surface. The recesses extend along a transverse direction of the light output surface and are distributed along a longitudinal direction of the light output surface. Each of the recesses includes a concave, curved wall and a vertical wall. The recesses are divided into two groups. The two groups of the recesses are symmetrically located on the light output surface and arranged at two sides with respect to a middle portion of the light output surface.

Other advantages and novel features of the present invention will become more apparent from the following detailed description of an embodiment/embodiments when taken in conjunction with the accompanying drawings.

### BRIEF DESCRIPTION OF THE DRAWINGS

FIG. 1 is an isometric view of an illumination device in accordance with a first embodiment of the present invention;

FIG. 2 is an inverted, cross-sectional view of the illumination device taken from line II-II of FIG. 1;

FIG. 3 is similar to FIG. 2, but shows light paths of light rays emitted from an LED of the illumination device;

FIG. 4 is an isometric view of an illumination device in accordance with a second embodiment of the present invention; and

FIG. 5 is an isometric view of a lens used in an illumination device in accordance with a third embodiment of the present invention.

### DETAILED DESCRIPTION

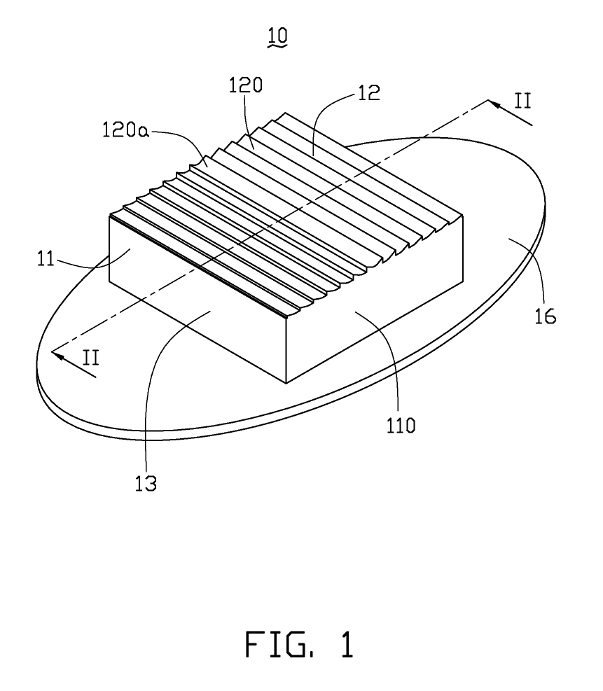

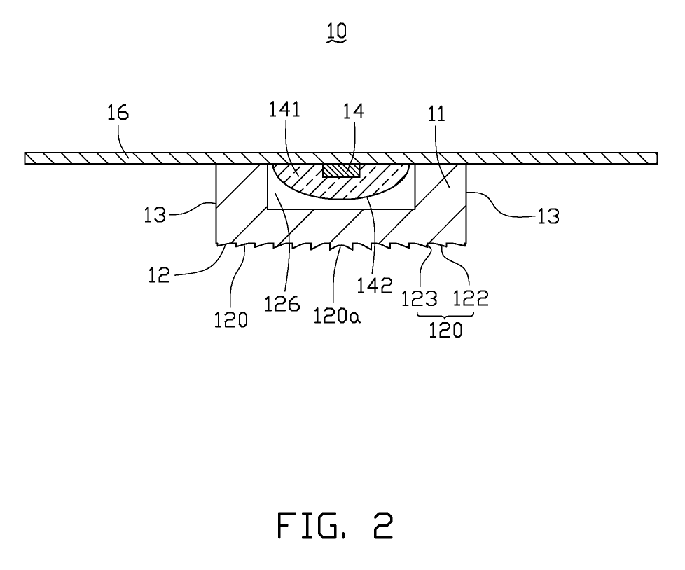

Referring to FIG. 1 and FIG. 2, an illumination device 10 in accordance with a first embodiment of the present invention is shown. The illumination device 10 includes an optical lens 11, an LED 14 and a reflective base 16. The LED 14 is attached to the reflective base 16. The lens 11 is disposed on the reflective base 16 for covering the LED 14.

The lens 11 has a rectangular body 110. The lens 11 includes a first light output surface 12 on a top of the body 110 and four second light output surfaces 13 below the first light output surface 12. The second light output surfaces 13 are located at four lateral sides of the body 110 of the lens 11, respectively. When the illumination device 10 is used as a street lamp, the first light output surface 12 is used to face a street or road (not shown). The first light output surface 12 defines a central recess 120a and a plurality of lateral recesses 120. The recesses 120a, 120 extend along a transverse direction of the first light output surface 12. The recesses 120a, 120 are parallel and arranged adjacent to each other along a longitudinal direction of the first light output surface 12. The central recess 120a is located in a middle of the first light output surface 12 and has a U-shaped cross-section. The lateral recesses 120 are divided into two groups, which are symmetrically distributed on the light output surface 12 and arranged at two sides with respect to the central recess 120a.

Each recess 120 has a curved wall 122 and a vertical wall 123. The curved wall 122 is a concave, smooth surface and the vertical wall 123 is a vertical, smooth surface. The vertical wall 123 is located at a side of each recess 120 adjacent to the central recess 120a, and the curved wall 122 is located at another opposite side of each recess 120 remote from the central recess 120a.

Curvatures of the recesses 120 gradually decrease from the middle portion towards two longitudinal sides of the first light output surface 12, so that light rays through the middle portion of the first light output surface 12 can be dispersed in a large angle, light rays through the sides of the first light output surface 12 can be dispersed in a small angle. The number of the recesses 120 is determined according to actual need. In general, more recesses 120 are suitable for obtaining a broad illumination range because the recesses 120 in a large density can make each of the recesses 120 have a large curvature. Furthermore, the lens 11 can be made thinner so as to save material and cost.

The second light output surfaces 13 are flat, smooth surfaces. Alternatively, the second light output surfaces 13 can also define a plurality of recesses according to actual need. The reflective base 16 has an elliptical shape. A long axis direction of the elliptical shape of the reflective base 16 is aligned with the longitudinal direction of the first light output surface 12. Alternatively, the reflective base 16 can be rectangular. The reflective base 16 is made by spreading a high reflective material on a surface of a circuit board. The surface of the reflective base 16 having the reflective material thereon is used to face the street or the road. The illumination device 10 can be fixed to a heat dissipation base (not shown) via the reflective base 16.

The lens 11 defines a rectangular groove 126 on a side opposite to the first light output surface 142 thereof. The LED 14 is received in the groove 126. The LED 14 includes an encapsulation 141 encapsulating a chip body (not labeled). The encapsulation 141 has a light emitting surface 142, which faces the first light output surface 12 of the lens 11.

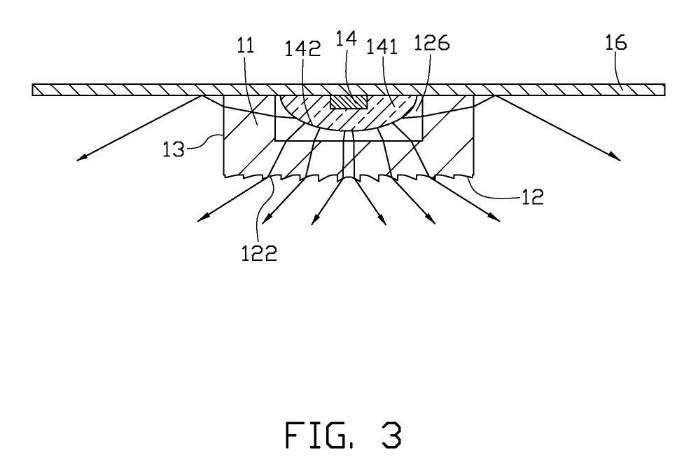

Referring to FIG. 3, in operation, light rays are emitted from the light emitting surface 142 of the LED 14. Then, the light rays extend into the lens 11, and at last come out from the light output surfaces 12, 13. The light rays through the recesses 120 of the first light output surface 12 are refracted by the walls 122, 123 to disperse along the longitudinal direction of the first light output surface 12, so as to form a broad light field for illuminating the street. The light rays through the second light output surfaces 13 disperse to lateral sides of the lens 11. A portion of the light rays incident on the reflective base 16 is reflected by the reflective base 16 so as to emit towards the street for further obtaining a broader light field. Thus, the illumination device 10 can obtain a broad light field by simply defining the recesses 120, 120a on the first light output surface 12. The cost of the illumination device 10 is accordingly greatly reduced.

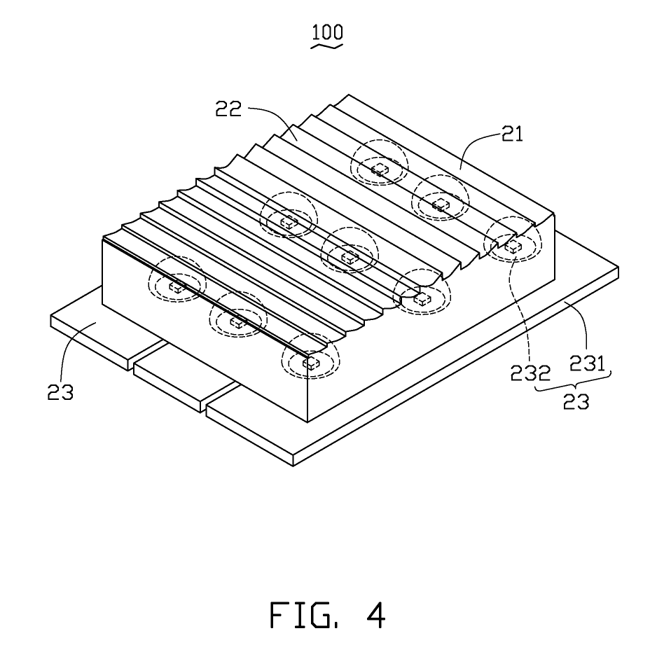

Referring to FIG. 4, an illumination device 100 in accordance with a second embodiment of the present invention is shown. The illumination device 100 includes a large lens 21 and three groups of LED modules 23. The large lens 21 has a top surface 22, which is similar to the first light output surface 12 of the lens 11. Each group of the LED modules 23 includes a rectangular, reflective base 231 and a plurality of LEDs 232 equidistantly mounted on the reflective base 231. The three reflective bases 231 are spaced from each other and secured to a same heat dissipation base (not shown). The large lens 21 is disposed on the LED modules 23 for covering the LEDs 232.

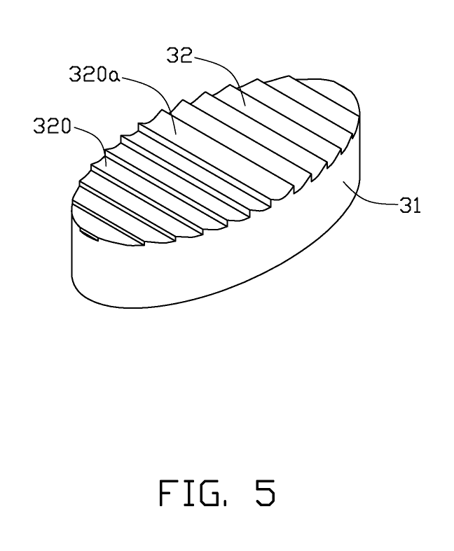

A shape of the lens 11 is not limited to rectangle. Referring to FIG. 5, a lens 31, which can be used in an illumination device in accordance with a third embodiment of the present invention, is shown. The lens 31 has an elliptical configuration. The lens 31 includes a light output surface 32 at a top thereof. The light output surface 32 includes a central recess 320a and a plurality of lateral recesses 320, which are similar to the recesses 120a, 120 of the first light output surface 12 of the lens 11. The recesses 320a, 320 are distributed along a long axis of the elliptical configuration of the lens 31.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lens of an illumination device comprising:
a body having a bottom for receiving a light source;
a light output surface located on a top of the body; and
a plurality of recesses defined in the light output surface, wherein
the recesses extend along a transverse direction of the light output surface and are distributed along a longitudinal direction of the light output surface, each of the recesses includes a concave, curved wall, the recesses are divided into two groups, the two groups of the recesses are symmetrically located on the light output surface and arranged at two sides with respect to a middle portion of the light output surface.

2. The lens of an illumination device as claimed in claim 1, wherein the recesses are parallel and adjacent to each other along the longitudinal direction.

3. The lens of an illumination device as claimed in claim 1, wherein each of the recesses further includes a vertical wall, the vertical wall is located at a side of the each of the recesses adjacent to the middle portion of the light output surface, the curved wall is located at another opposite side of the each of the recesses remote from the middle portion of the light output surface.

4. The lens of an illumination device as claimed in claim 1, wherein the light output surface further comprises a central recess, the central recess is located in the middle portion of the light output surface and has a U-shaped cross-section.

5. The lens of an illumination device as claimed in claim 1, wherein curvatures of the recesses gradually decrease from the middle portion towards two longitudinal sides of the light output surface.

6. The lens of an illumination device as claimed in claim 1, wherein the lens further comprises at least one another light output surface, which is located at a lateral side of the body.

7. The lens of an illumination device as claimed in claim 1, wherein the shape of the lens is selected from a group consisting of rectangular and elliptical.

8. An illumination device comprising:
a lens;
at least one reflective base and at least one LED mounted on the at least one reflective base, wherein
the lens is disposed on the at least one reflective base for covering the at least one LED, the lens includes a light output surface locating on a top of the lens, a plurality of recesses are defined in the light output surface, the recesses extend along a transverse direction of the light output surface and are distributed along a longitudinal direction of the light output surface, each of the recesses includes a concave, curved wall, the recesses are divided into two groups, the two groups of the recesses are symmetrically located on the light output surface and arranged at two sides with respect to a middle portion of the light output surface.

9. The illumination device as claimed in claim 8, wherein the at least one LED includes an encapsulation, the encapsulation including a light emitting surface facing the light output surface of the lens.

10. The illumination device as claimed in claim 8, wherein the number of the reflective base is more than two, the number of the LED is more than two, each of the reflective bases comprises at least an LED mounted on the each of the reflective bases.

11. The illumination device as claimed in claim 8, wherein the recesses of the lens are parallel and arranged adjacent to each other along the longitudinal direction.

12. The illumination device as claimed in claim 8, wherein each of the recesses further includes a vertical wall, the vertical wall is located at a side of the each of the recesses adjacent to the middle portion of the light output surface, the curved wall is located at another opposite side of the each of the recesses remote from the middle portion of the light output surface.

13. The illumination device as claimed in claim 8, wherein curvatures of the recesses gradually decrease from the middle portion towards two longitudinal sides of the light output surface of the lens.
